(19) United States
(12) Patent Application Publication
(10) Pub. No.: US 2010/0172821 A1
(43) Pub. Date: Jul. 8, 2010

(54) METHOD OF PREPARATION OF SPHERICAL SUPPORT FOR OLEFIN POLYMERIZATION CATALYST

(75) Inventors: Eun-Il Kim, Daejon (KR); Young-Joo Lee, Inchon (KR); Hoe-Chul Jung, Chungcheongnam-do (KR); Joon-Ryeo Park, Seoul (KR)

Correspondence Address: YOUNG & THOMPSON, 209 Madison Street, Suite 500, Alexandria, VA, 22314, US

(73) Assignee: SAMSUNG TOTAL PETROCHEMICALS CO., LTD., Seosan-shi, Chungcheongnam-do (KR)

(21) Appl. No.: 12/676,268

(22) PCT Filed: Sep. 11, 2008
(86) PCT No.: PCT/KR2008/005375

§ 371 Date: Mar. 3, 2010

(30) Foreign Application Priority Data
Dec. 28, 2007 (KR) 10-2007-0139594

(51) Int. Cl. C01F 5/26

(52) U.S. Cl. 423/497

(57) ABSTRACT

Provided is a method of preparation of dialkoxy magnesium that is used as a support for an olefin polymerization catalyst for polyolefin preparation. Specifically, provided is a method of preparation of a support for an olefin polymerization catalyst, which comprises preparation of dialkoxy magnesium by reacting magnesium metal with alcohol in the presence of a reaction initiator, wherein bromine is used as the reaction initiator so as to obtain spherical dialkoxy magnesium.

### TECHNICAL FIELD

The present invention relates to a method of preparation of dialkoxy magnesium used as a support for an olefin polymerization catalyst for polyolefin preparation. More particularly, the present invention relates to a method of preparation of a support for an olefin polymerization catalyst, which comprises preparation of dialkoxy magnesium by reacting magnesium metal with alcohol in the presence of a reaction initiator, characterized by using bromine as the reaction initiator so as to obtain spherical dialkoxy magnesium.

### BACKGROUND ART

One of the most widely used olefin polymerization catalysts is currently, Ziegler-Natta catalyst supported by magnesium chloride. The magnesium chloride-supported Ziegler-Natta catalyst is a solid catalyst component normally comprised of magnesium, titanium, halogen and an electron donating organic compound. When being used in polymerization of alpha-olefin such as propylene, it may be mixed and used with an organoaluminum compound as a cocatalyst and an organosilane compound as a stereoregularity regulator, at a suitable ratio. Since supported solid catalysts for olefin polymerization are used in various commercialized polymerization processes such as slurry polymerization, bulk polymerization, gas phase polymerization and the like, they need to satisfy various requirements regarding a particle morphology such as suitable particle dimension and shape, uniform particle size distribution, minimized amount of macroparticles or microparticles and high bulk density, etc., as well as basically required properties such as high catalyst activity and stereoregularity.

For methods for improving particle morphology of a support for olefin polymerization catalyst, a recrystallization and reprecipitation method, a spray drying method, a chemical method and the like have been known in the art. Among them, a method for preparing a catalyst by using dialkoxy magnesium as a support, obtained from the reaction between magnesium and alcohol, i.e. one of the chemical methods, has been getting great attentions recently, since it is possible to provide a catalyst having significantly improved activity and providing polymers with high stereoregularity, as compared to other conventional methods. However, when using dialkoxy magnesium as a support, the particle shape, particle size distribution and bulk density thereof will directly affect the resulted catalyst and the particle characteristics of the produced polymers. Therefore, it is needed to produce a dialkoxy magnesium support having a uniform size, a spherical shape and sufficiently high bulk density, from the reaction between magnesium and alcohol. Particularly, a large amount of macroparticles deteriorate the flowability of polymers, and thus would make problems when being applied to a mass-production in plant-scale.

Various methods for preparing dialkoxy magnesium having a uniform shape have been disclosed in conventional technical literatures. U.S. Pat. Nos. 5,162,277 and 5,955,396 suggest methods for preparing a support having a size of 5-10 μm, by recrystallizing magnesium ethyl carbonate in a solution of various additives and solvent, wherein the magnesium ethyl carbonate is obtained from carboxylation of amorphous diethoxy magnesium. Further, Japanese laid-open patent publication Heisei06-87773 discloses a method for preparing spherical particles through processes of spray-drying an alcohol solution of diethoxy magnesium which has been carboxylated by carbon dioxide, and then decarboxylation thereof. However, these conventional methods require complicated processes using various raw materials and are not able to provide suitable particle size and morphology of the support, to the desired level.

In the meantime, Japanese laid-open patent publications Heisei03-74341, 04-368391 and 08-73388 provide synthetic methods of spherical or oval diethoxy magnesium through the reaction of magnesium metal with ethanol in the presence of iodine. However, in such methods for preparing diethoxy magnesium, a large amount of reaction heat and hydrogen are generated during the reaction which occurs very rapidly. Therefore, in said methods, it is difficult to regulate the reaction rate to the appropriate level, and the resulted product, diethoxy magnesium support disadvantageously comprises a great amount of microparticles or heterogeneous macroparticles formed of conglomerated particles.

When using a catalyst produced by using such support in olefin polymerization as it is, it causes problems such as polymers with excessively increased particle size, or destruction of particle shape owing to heat of polymerization, which causes serious troubles in process.

### DISCLOSURE

### Technical Problem

For resolving the above-mentioned problems in prior arts, the object of the present invention is to provide a method of preparation of a spherical support for an olefin polymerization catalyst, wherein the support has a smooth-surfaced spherical particle shape and a uniform size, so that it can be suitably used in preparation of a catalyst which can sufficiently meet the particle properties required in commercial olefin polymerization processes such as slurry polymerization, bulk polymerization and gas phase polymerization.

### Technical Solution

The present invention discloses a method of preparation of a dialkoxy magnesium support for an olefin polymerization catalyst, which comprises a step of reacting magnesium metal with alcohol (ROH), characterized by using bromine as a reaction initiator.

Magnesium metal used in the preparation method of a support according to the present invention is not strictly limited in its particle shape, however its average particle size is preferably 10-300 μm in powder type, and more preferably 50-200 μm in powder type. When the average particle size of magnesium metal is less than 10 μm, the average particle size of the resulting support becomes too small. In the meantime, when it is more than 300 μm, it is not desirable since the average particle size of the support becomes too big, and the support would not have a uniform spherical shape.

As for alcohol used in the preparation method of a support according to the present invention, an alcohol selected from, for example, aliphatic alcohols having a general formula of ROH (wherein, R is alkyl having C₁-C₆), such as methanol, ethanol, n-propanol, isopropanol, n-butanol, isobutanol, n-pentanol, isopentanol, neo-pentanol, cyclopentanol, cyclohexanol and the like, and aromatic alcohols such as phenol, or a mixture of one or more of said alcohols is preferably used herein. More preferably, one or two or more of alcohols selected from methanol, ethanol, propanol and butanol, and the most preferably ethanol is used. In the mixture of two or more alcohols, the mixing ratio thereof is not specifically limited.

As for the amount of alcohol relative to magnesium metal used in the preparation of a support according to the present invention is represented as the ratio of magnesium metal (by weight) to ethanol (by volume) being preferably 1:5-1:50, and more preferably 1:7-1:20. When the ratio is less than 1:5, it is not preferred since viscosity of the slurry is increased that it is difficult to achieve homogenous mixing. While, when it is more than 1:50, it causes other problems such that the bulk density of the resulting support becomes significantly decreased or the particle surface becomes coarse.

Bromine used in the method of preparation of a support according to the present invention is preferably used at the amount of 0.1-20 parts by weight per 100 parts by weight of magnesium metal. When it is less than 0.1 parts by weight, it is not preferred since the reaction rate becomes too slow; and when it is more than 20 parts by weight, the particle size of the resulted product becomes too increased, or micro-particles could be produced in a great amount.

In the method of preparation of a support according to the present invention, the reaction of magnesium metal and alcohol in the presence of bromine, is carried out preferably at the temperature of 25-110?, and more preferably at 25-75° C. When the temperature is less than 25° C., the reaction becomes undesirably too slow, and when it is more than 110° C., it is not preferred since the reaction occurs so rapidly that the amount of microparticles becomes suddenly increased, and further, particles get conglomerated, and therefore, it is not possible to obtain a uniform spherical support having a desired size. In addition, it is also possible to carry out the reaction at boiling temperature of alcohol under reflux.

### ADVANTAGEOUS EFFECTS

By the method of preparation of a support according to the present invention, a support having a spherical particle shape can be obtained, which can be suitably used commercially.

### DESCRIPTION OF DRAWINGS

FIG. 1 is a SEM photo of supports prepared by using iodine as a reaction initiator.

FIG. 2 is a SEM photo of supports prepared by using bromine as a reaction initiator.

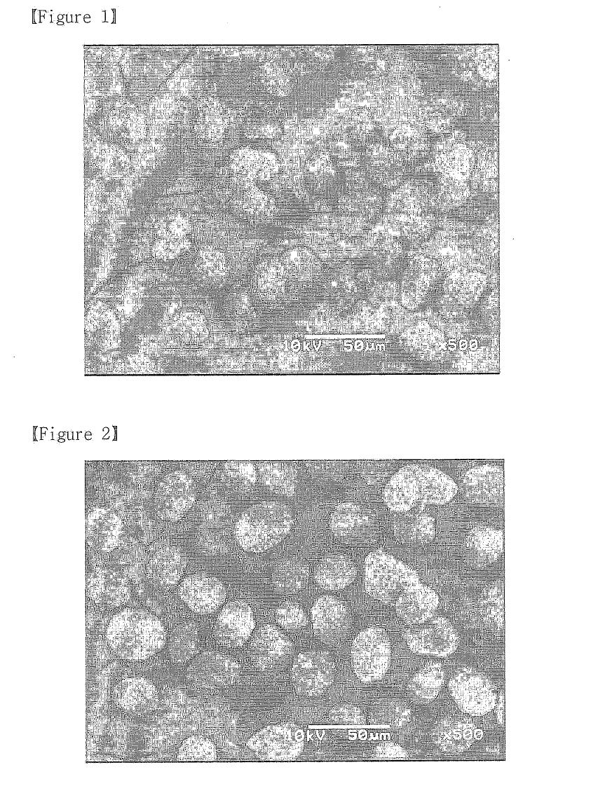

### MODE FOR INVENTION

Hereinafter, the present invention is further illustrated in detail through the examples and comparative examples given below. However, the invention is by no means restricted or limited by such examples.

### Examples 1

To a 5 L volume ceramic reactor equipped with a stirrer, an oil heater and a reflux condenser, sufficiently purged with nitrogen, 2.1 g (13 mmol) of bromine, 30 g (1238 mmol) of magnesium metal (powdered product having an average particle size of 100 μm) and 130 ml of anhydrous ethanol were added at room temperature. Then, the temperature of the reactor was gradually raised to 78° C., while operating the stirrer at the speed of 240 rpm, so as to maintain reflux of ethanol. In about five minutes, 30 g of magnesium metal (powder having an average particle size of 100 μm) and 200 ml of ethanol were added to the reactor, and it was allowed to react for 20 minutes. Since hydrogen is generated upon initiation of the reaction, the reactor was left open so that the generated hydrogen can be released from the reactor, and thus the pressure of the reactor was maintained under atmospheric pressure. Upon completion of hydrogen generation, 10 g of magnesium metal (powder having an average particle size of 100 μm) and 150 ml of ethanol were added three times more, and allowed to react for 20 minutes, respectively. Completing the addition of magnesium metal and ethanol, the reactor temperature and agitation speed in reflux conditions were maintained two hours (aging). After aging, the resulted product was washed 3 times with 1,000 ml of n-hexane for each wash, at 50° C. The washed product was dried for 24 hours under a nitrogen stream, thereby obtaining 269.7 g (yield: 95.5%) of a white solid powder with good flowability.

The particle shape of the dried product was observed with an electron microscope (FIG. 2), and the bulk density was measured.

The accumulated distribution of particle size was obtained by measuring particle size with Laser Particle Analyzer, and the average diameter of particle and the size distribution index were determined as follows:

\textcircled{1} average diameter (D₅₀: a particle size corresponding to the accumulated weight of 50%,

\textcircled{2} size distribution index=(D₉₀-D₁₀)/D₅₀ (in which, D₉₀ represents a particle size corresponding to the accumulated weight of 90%, and D₁₀ represents a particle size corresponding to the accumulated weight of 10%).

The results were shown in Table 1.

### Example 2

To a 5 L volume ceramic reactor equipped with a stirrer, an oil heater and a reflux condenser, sufficiently purged with nitrogen, 2.1 g (13 mmol) of bromine, 30 g (1238 mmol) of magnesium metal (powdered product having an average particle size of 100 μm) and 330 ml of anhydrous ethanol were added at room temperature. Then, the temperature of the reactor was gradually raised to 78° C., while operating the stirrer at the speed of 240 rpm, and it was allowed for reaction for 20 minutes. Since hydrogen is generated upon initiation of the reaction, the reactor was left open so that the generated hydrogen can be released from the reactor, and thus the pressure of the reactor was maintained under atmospheric pressure. Upon completion of hydrogen generation, 10 g of magnesium metal (powder having an average particle size of 100 μm) and 150 ml of ethanol were added three times more, and allowed to react for 20 minutes, respectively. Completing the addition of magnesium metal and ethanol, the reactor temperature and agitation speed in reflux conditions were maintained two hours (aging). After aging, the resulted product was washed 3 times with 1,000 ml of n-hexane for each wash, at 50° C. The washed product was dried for 24 hours under a nitrogen stream, thereby obtaining 274.2 g (yield: 97.1%) of a white solid powder with good flowability.

The particle shape of the dried product was observed with an electron microscope, the bulk density was measured, and the average particle diameter and the size distribution index were determined as in Example 1.

The results were shown in Table 1.

### Comparative Example 1

To a 5 L volume ceramic reactor equipped with a stirrer, an oil heater and a reflux condenser, sufficiently purged with nitrogen, 3 g of iodine, 15 g of magnesium metal (powdered product having an average particle size of 100 μm) and 240 ml of anhydrous ethanol were added. Then, the temperature of the reactor was raised to 78° C., while operating the stirrer at the speed of 240 rpm, so as to maintain reflux of ethanol. Nest, 15 g of magnesium metal (powder having an average particle size of 100 μm) and 240 ml of ethanol were added to the reactor in three portions at an interval of 20 minutes. After completing the addition of magnesium metal, the agitation speed was maintained constant for 2 hours, under reflux conditions of ethanol (aging). After aging, the resulted product was washed 3 times with 1,000 ml of n-hexane for each wash, at 50° C. The washed product was dried for 24 hours under a nitrogen stream, thereby obtaining 270 g (yield: 95.6%) of a white solid powder.

The particle shape of the resulted product was observed, the bulk density was measured, and the average particle diameter and the size distribution index were determined as in Example 1.

The results are shown in Table 1.

TABLE 1

| | | | Average | |
|---|---|---|---|---|
| | | Bulk | particle | size |
| | Particle | density | diameter | distribution |
| | shape | (g/cc) | (D₅₀, μm) | index |
| Ex. 1 | sphere | 0.31 | 28.8 | 0.76 |
| Ex. 2 | Sphere | 0.32 | 29.2 | 0.80 |
| Com. | Coarse | 0.30 | 21.4 | 1.21 |
| Ex. 1 | sphere | | | |

As shown in Table 1, it can be found that the particle shape of Examples 1 and 2 is more spherical and has a smooth surface, as compared to that of Comparative Example 1. Further, the bulk density of each Example is more than that of Comparative Example 1, while the size distribution of Examples is remarkably uniform compared to that of Comparative Example 1.

### INDUSTRIAL APPLICABILITY

According to the present invention, a smooth-surfaced spherical support with uniform size can be provided, and the support is suitable for a preparation of a catalyst which can sufficiently meet the particle properties required in commercial olefin polymerization process.

1. A method of preparation of a spherical support for an olefin polymerization catalyst, which comprises a step of reacting magnesium metal with alcohol in the presence of a reaction initiator, wherein bromine is used as the reaction initiator.

2. The method of preparation of a spherical support for an olefin polymerization catalyst according to claim 1, wherein said bromine is used at the amount of 0.1-20 parts by weight per 100 parts by weight of the magnesium metal.

3. The method of preparation of a spherical support for an olefin polymerization catalyst according to claim 1, wherein said alcohol is one or two or more selected from the group consisting of aliphatic alcohols having a general formula of ROH (wherein, R is alkyl having C₁-C₆) and aromatic alcohols.

4. The method of preparation of a spherical support for an olefin polymerization catalyst according to claim 1, wherein the magnesium metal and the alcohol are used at the amount ratio of magnesium metal (by weight): alcohol (by volume) being 1:5-1:50.
